(19) United States
(12) Patent Application Publication
(10) Pub. No.: US 2010/0246313 A1
(43) Pub. Date: Sep. 30, 2010

(54) Truck Mixer

(75) Inventors: Berthold Ruf, Schoneburg (DE); Martin Wittig, Biberach (DE)

Correspondence Address: DILWORTH & BARRESE, LLP, 1000 WOODBURY ROAD, SUITE 405, WOODBURY, NY, 11797, US

(73) Assignee: LIEBHERR-MISCHTECHNIK GMBH, Bad Schussenried (DE)

(21) Appl. No.: 12/730,581

(22) Filed: Mar. 24, 2010

(30) Foreign Application Priority Data
Mar. 25, 2009 (DE) UM202009004187.5

(51) Int. Cl. B28C 5/18

(52) U.S. Cl. 366/63

(57) ABSTRACT

The present invention relates to a truck mixer with a mixing drum mounted and rotatable on a vehicle chassis, wherein the mixing drum is supported on the rear by means of a large roller bearing.

### BACKGROUND OF THE INVENTION

The present invention relates to a truck mixer with a mixing drum mounted and rotatable on a vehicle chassis, wherein a bearing of the mixing drum consists of a bearing pair comprising a race and at least one castor.

In known concrete mixing trucks, the part of the mixing drum pointing towards the rear of the vehicle is supported on two rollers so as to rest freely thereon. In this way, a compensation for otherwise occurring tensions or deformations e.g. by torsions of the chassis in driving operation can be created by possible relative movements in axial direction.

The free support prevents the occurrence of tensions in the drum bearing due to movements or deformations in the chassis, since as a result of these deformations relative movements can occur between race and roller.

Due to these relative movements in axial direction, the roller must be significantly wider than the race, in order to ensure the safe support in all driving conditions. In all attachment parts in the rear region of the drum, clearances must also be provided for these movements. However, the utilization of the installation space available thereby is restricted. For example, the accommodation of filling and/or draining parts is limited.

Since the angular position between race and roller can change as a result of said deformations, either the roller or the race is constructed with a crowned surface, so as to always ensure sufficient rest in rolling contact. Such pairing of roller bearings, however, is not optimal, since rolling also is effected in axial direction. Furthermore, such pairing of roller bearings places high demands on material and construction.

Furthermore, with this type of bearing it can occur that the mixing drum is lifted off from the rollers e.g. when driving through potholes. When the drum returns to the rollers, this “bouncing” results in increased mechanical loads and an increased nuisance by noise.

Since the bearing furthermore is completely open and accessible to the environment, dirt can attach to the race and lead to an increased wear of race and rollers. The attachment of dirt also can increase the noise emissions. Furthermore, the access to the contact region of castors and race must be protected by special covers, in order to prevent possible dangers caused by drawing-in and/or squeezing by this bearing pair.

### SUMMARY OF THE INVENTION

Therefore, it is the object of the present invention to develop a truck mixer as mentioned above in an advantageous way, in particular to the effect that the same includes a rear-side bearing which operates with less wear and is safer in operation and in which a smoother running of the mixing drum is possible.

In accordance with the invention, this object is solved by a truck mixer with the features of claim 1 Accordingly, it is provided that a truck mixer includes a mixing drum mounted and rotatable on a vehicle chassis, wherein the mixing drum is supported on the rear by means of a large roller bearing.

The use of a large roller bearing involves the advantage that a smooth-running, wear-optimized and low-noise-emission pair of roller bearings and in particular a standard part can be used. Since such large roller bearings also are available in encapsulated form, it is no longer necessary to ensure an inaccessibility of the bearing components rolling on each other or to make them less accessible by additional covers. Since the support by means of large roller bearings is no free support, “bouncing” of the mixing drum no longer can occur e.g. when driving through potholes.

Furthermore, it can be provided that the large roller bearing fully encloses the mixing drum and/or that the large roller bearing has an inner race, wherein the inner race of the large roller bearing is attached to the outside of the mixing drum on the rear, preferably on the rear edge of the mixing drum. Since the positions of the bearing and of the drum outlet thus can no longer move relative to each other, the clearances for filling and/or draining parts can be reduced and hence their properties can be improved.

Furthermore, it is possible that at least one compensating means is directly and/or indirectly connected with the large roller bearing, by means of which relative movements are made possible in axial direction of the truck mixer. This involves the advantage that no tensions can be introduced into the chassis and/or also vice versa from the chassis into the large roller bearing.

In addition, it is conceivable that the compensating means comprises a pivotal connection and/or that the large roller bearing is connected with the chassis by means of a pivotal connection.

Advantageously, the compensating means comprises a prop and at least one at least partly pivotable bearing and/or the pivotal connection is releasably attached to the truck mixer. For example, assembly directly to the stationary outer race of the large roller bearing is possible, whereby weight can advantageously be saved for supporting parts and adjusting activities during assembly. The omission of these supporting parts likewise improves the accessibility to the mixing drum in the outlet region and thus facilitates cleaning. Furthermore, the maintenance and in particular the replacement of defective parts is facilitated.

It can be provided that the bearing is a rotatable bolt connection. This provides for a particularly simple and efficient bearing, for example by a pairing of bolt and sliding bush, which ensures e.g. the necessary movement in axial direction.

Furthermore, it is possible that the prop includes one bearing each on the chassis side and on the bearing side, by means of which relative movements are made possible in axial direction of the truck mixer.

Advantageously, it can be provided that the chassis-side bearing is articulated to the end of the chassis, preferably to the outermost end of the chassis.

Furthermore, it is possible that the support-side bearing is eccentrically articulated to the large roller bearing.

Advantageously, the prop is an angle bracket and/or two props are provided. Relative movements in axial direction between the rear-side bearing and the chassis hence are possible, so that a load compensation can take place. Supporting the bearing by means of e.g. movable props furthermore can provide the advantage that one bearing point each per chassis frame side is sufficient. This results in a considerable gain in installation space below the mixing drum, which can be utilized for accommodating components of the truck mixer system.

In addition, it can be provided that the angle bracket has two legs, with the first leg being longer than the second leg.

Advantageously, the legs of the angle bracket include an obtuse or reflex angle, in particular an angle in the range between 100° and 150°, in particular between 120° and 150°, particularly preferably an angle of 135°±5°.

It is possible that the attachment of the large roller bearing is effected by means of releasable fastening means. As a result, a replacement in the case of a defect is easily possible. The so far higher maintenance costs as a result of the welded connections of the components of the rear bearing can now be avoided.

In principle, however, it is also possible that the attachment of the large roller bearing is at least partly effected by means of welded joints.

Particularly advantageously, a water tank is arranged in the rear region below the mixing drum. Due to the rear bearing in accordance with the invention, a considerable gain in installation space can be obtained for example in the rear region below the mixing drum. This gain in installation space can be utilized e.g. for the installation of the water tank of the water system, possibly even of the entire water system of the truck mixer. As a result, the center of gravity of the entire vehicle is lowered. At the same time, installation space overlaps between water tank and exhaust gas system of the carrier vehicle can be avoided.

Furthermore, it can be provided that the mixing drum can be driven via the large roller bearing and/or that in the vicinity of the large roller bearing means are provided by means of which the mixing drum can be driven. As a result, the transmission in the vicinity of the drum base or at the front end of the mixing drum can be omitted and be replaced by a simple and much less expensive bearing.

### BRIEF DESCRIPTION OF THE DRAWINGS

Further details and advantages will now be explained in detail with reference to an embodiment illustrated in the drawing. In which:

FIG. 1: shows a schematic view of a known truck mixer;

FIG. 2: shows a sectional representation A-A of the rear bearing of the mixing drum of the truck mixer shown in FIG. 1; and

FIG. 3: shows a schematic view of a truck mixer in accordance with the invention.

### DESCRIPTION OF THE PREFERRED EMBODIMENTS

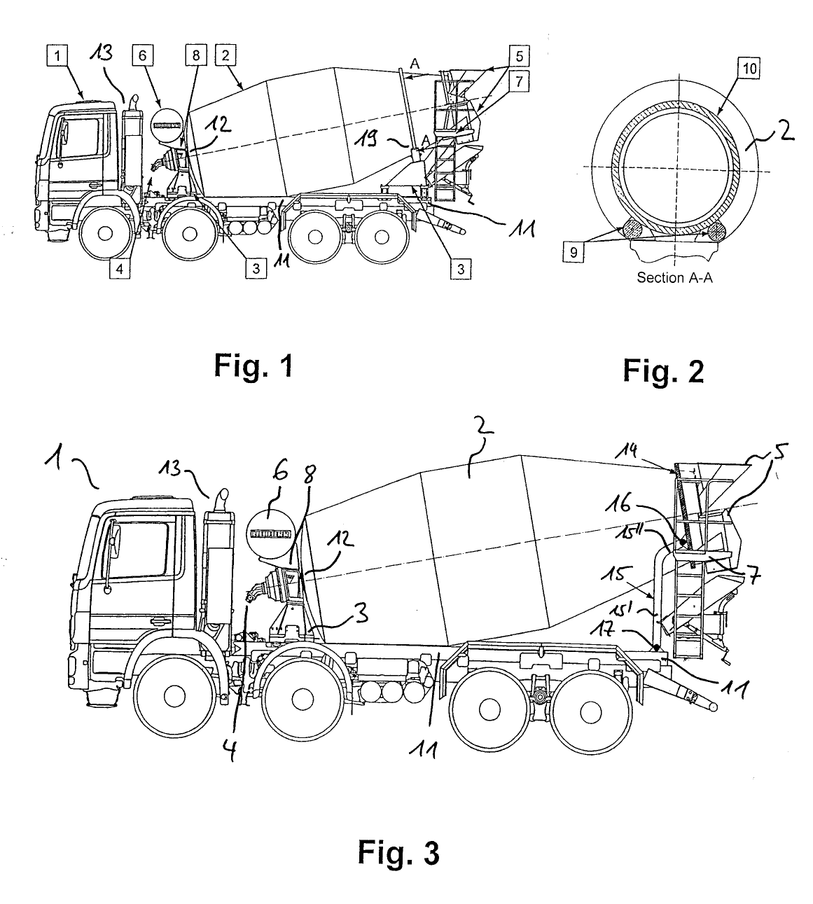

FIG. 1 shows a known truck mixer 1 in accordance with the prior art, which includes a rotatable mixing drum 2 mounted on a truck with a built-in spiral not shown in detail. By rotating the drum 2 in one direction, charge can be drawn in and thoroughly mixed, and by rotating in the opposite direction, the charge can be conveyed out.

Beside the mixing drum 2, the main components of the truck mixer body are the supporting structure 3 of the rear bearing 19 of the mixing drum 2, the rotary drive 4 of the mixing drum 2, chutes and funnels 5 for charging and discharging, and a water system 6 and a ladder 7 e.g. for cleaning the body. The supporting structure 3 is mounted on the rear of the chassis 11 of the truck mixer 1. A comparable supporting structure 3 is also provided for attachment of the front bearing of the mixing drum 2 on the chassis 11.

At its front end, the drum base 12, the mixing drum 2 is attached to a rotatable flange of a transmission 8, in order to transmit the power of the drive components, in particular of the rotary drive 4, to the mixing drum 2. The flange of the transmission 8 is mounted in pendulum fashion, in order to compensate the movements of the mixing drum 2 by deformations in the chassis 11 of the truck. Such deformations can occur in particular in driving operation, for example during use of the truck mixer 1 as concrete mixer on its way from the concrete factory to the site of use. On this way, the material to be mixed, here concrete, must be intermixed continuously, in order to prevent a solidification and hardening of the material to be mixed.

To provide for relative movements in axial direction of the vehicle in the backward, rear region of the mixing drum 2, the mixing drum 2 freely rests on two castors 9. To prevent the mixing drum 2 from being deformed under dead load due to the weight at the support or the rear bearing, a race 10 is firmly welded to the mixing drum 2. In this way, the mixing drum is reinforced in the bearing region, so that a deformation under dead load cannot occur.

FIG. 2 shows the section A-A as it is indicated in FIG. 1. The race 10 stands on the castors 9, so that in the case of a rotation of the mixing drum 2 race 10 and rollers 9 will roll on each other.

FIG. 3 shows an embodiment of a truck mixer 1 of the invention in a schematic view. Equal components as in FIGS. 1 and 2 are designated with the same reference numerals.

The so far free rear support 19 of the mixing drum 2 with a race 10 on rollers 9 is replaced by a large roller bearing 14 screwed to the mixing drum 2, which is connected with the chassis frame 11 via movably mounted props 15.

Due to the firm connection of the mixing drum 2 to the chassis frame 11, “bouncing” in driving operation of the truck mixer 1 no longer can occur. Due to the movably mounted props 15, however, no tensions are introduced into the chassis frame 11 and/or vice versa into the large roller bearing 14.

The large roller bearing 14 is configured as an encapsulated roller bearing 14. Due to the use of the large roller bearing 14, the drum operation is much smoother and safer. The noise emissions are lower than in known truck mixers and no additional protective covers are required any longer, since due to its encapsulation the large roller bearing 14 does not provide for an unimpeded access to the components rolling on each other.

Since the rear bearing is supported on movably mounted props 15, one bearing point per chassis frame side is sufficient, whereby a considerable gain in installation space is obtained below the mixing drum 2. Due to the movably mounted props 15, no tensions are introduced into the chassis frame and the necessary relative movements are made possible in axial direction. The props 15 are mounted in rotatable bolt connections 16, 17 both on the chassis side and on the bearing side. Both the chassis-side bearing 17 and the support-side bearing 16 are a pairing of bolt and sliding bush, which provides for a relative movement in axial direction of the truck mixer 1.

The two props 15 are configured as angle brackets 15, with the chassis-side first leg 15′ being longer than the bearing-side second leg 15″. The legs 15′, 15″ include an angle of about 135°.

Since the positions of the bearing and of the drum outlet no longer can move relative to each other, the clearances for filling and/or draining parts are reduced in the embodiment of the truck mixer 1 of the invention as described here.

In a particularly advantageous embodiment, the gain in installation space below the mixing drum 2 is utilized for the installation of a water tank 6, whereby the center of gravity of the entire vehicle 1 is lowered. Thus, installation space overlaps between water tank 6 and exhaust gas system likewise are avoided.

Since all parts of the rear bearing are screwed, a replacement in the case of a defect is easily possible.

In a further, non-illustrated embodiment of the invention it is possible to drive the mixing drum 2 via the large roller bearing 14. As a result, the transmission 8 can be omitted and can be replaced by a likewise non-illustrated bearing of simpler construction, lighter in weight and less expensive.

1. A truck mixer (1) with a mixing drum (2) mounted and rotatable on a vehicle chassis (11), wherein the mixing drum (2) is mounted on the rear by a large roller bearing (14).

2. The truck mixer (1) according to claim 1, wherein the large roller bearing (14) fully encloses the mixing drum (2) and/or that the large roller bearing (14) has an inner race, and the inner race of the large roller bearing (14) is attached to the outside of the mixing drum (2) on the rear, preferably on the rear edge of the mixing drum (2).

3. The truck mixer (1) according to claim 1, wherein at least one compensating means (15) is directly and/or indirectly connected with the large roller bearing (14), by which relative movements are made possible in axial direction of the truck mixer (1).

4. The truck mixer (1) according to claim 1, wherein the compensating means (15) comprises a pivotal connection (16, 17) and/or that the large roller bearing (14) is connected with the chassis by a pivotal connection (16, 17).

5. The truck mixer (1) according to claim 3, wherein the compensating means (15) comprises a prop (15) and at least one at least partly pivotable bearing (16, 17) and/or that the pivotal connection (16, 17) is releasably attached to the truck mixer (1).

6. The truck mixer (1) according to claim 5, wherein the bearing (16, 17) is a rotatable bolt connection (16, 17).

7. The truck mixer (1) according to claim 5, wherein the prop (15) includes a bearing (16, 17) each on the chassis side and on the bearing side, by which relative movements are made possible in axial direction of the truck mixer (1).

8. The truck mixer (1) according to claim 7, wherein the chassis-side bearing (17) is articulated to the end of the chassis (11), preferably to the outermost end of the chassis (11).

9. The truck mixer (1) according to claim 7, wherein the support-side bearing (16) is eccentrically articulated to the large roller bearing (14).

10. The truck mixer (1) according to claim 5, wherein the prop (15) is an angle bracket (15) and/or two props (15) are provided.

11. The truck mixer (1) according to claim 10, wherein the angle bracket (15) has two legs (15′, 15″), and the first leg (15′) is longer than the second leg (15″).

12. The truck mixer (1) according to claim 11, wherein the legs (15′, 15″) of the angle bracket (15) include an obtuse or reflex angle, in particular an angle in the range between 100° and 150°, in particular between 120° and 150°, particularly preferably an angle of 135°±5°.

13. The truck mixer (1) according to claim 1, wherein the attachment of the large roller bearing (14) is effected by means of releasable fastening means or by a welded joint.

14. The truck mixer (1) according to claim 1, wherein in the rear region below the mixing drum (2) a water tank (6) is arranged.

15. The truck mixer (1) according to claim 1, wherein the mixing drum (2) can be driven via the large roller bearing (14) and/or in the vicinity of the large roller bearing (14) means are provided, by which the mixing drum (2) can be driven.

16. The truck mixer (1) according to claim 2, wherein at least one compensating means (15) is directly and/or indirectly connected with the large roller bearing (14), by which relative movements are made possible in axial direction of the truck mixer (1).

17. The truck mixer (1) according to claim 16, wherein the compensating means (15) comprises a pivotal connection (16, 17) and/or that the large roller bearing (14) is connected with the chassis by a pivotal connection (16, 17).

18. The truck mixer (1) according to claim 3, wherein the compensating means (15) comprises a pivotal connection (16, 17) and/or that the large roller bearing (14) is connected with the chassis by a pivotal connection (16, 17).

19. The truck mixer (1) according to claim 2, wherein the compensating means (15) comprises a pivotal connection (16, 17) and/or that the large roller bearing (14) is connected with the chassis by a pivotal connection (16, 17).

20. The truck mixer (1) according to claim 17, wherein the compensating means (15) comprises a prop (15) and at least one at least partly pivotable bearing (16, 17) and/or that the pivotal connection (16, 17) is releasably attached to the truck mixer (1).
